(19) United States
(12) Patent Application Publication
(10) Pub. No.: US 2010/0076955 A1
(43) Pub. Date: Mar. 25, 2010

(54) DATA NETWORK SERVICE BASED ON PROFILING CLIENT-ADDRESSES

(75) Inventors: Ate Sander Van Steenbergen, Groningen (NL); Gerard Lutterop, Zuidhorn (NL)

Correspondence Address: MICHAELSON & ASSOCIATES, P.O. BOX 8489, RED BANK, NJ, 07701-8489, US

(73) Assignee: KONINKLIJKE KPN N.V. The Hague, The Netherlands

(21) Appl. No.: 12/448,182

(22) PCT Filed: Dec. 19, 2007
(86) PCT No.: PCT/EP2007/011147

§ 371 Date: Nov. 9, 2009

Related U.S. Application Data
(60) Provisional application No. 60/875,638, filed on Dec. 19, 2006.

(51) Int. Cl. G06F 17/30; G06F 15/177

(52) U.S. Cl. 707/711; 709/220; 707/740; 707/E17.046; 707/769; 707/E17.014

(57) ABSTRACT

A service is provided on a data network. The data network comprises a plurality of clients and one or more servers. Each specific client has a specific network address. In a database, respective groups are formed of the network addresses. Each respective group has a respective profile. Each respective profile is determined by one or more respective commonalities in requests sent by the clients to the one or more servers over a period of time. Each specific network address is grouped in at least one specific group based on the requests sent by the specific client and matching a specific profile.

### FIELD OF THE INVENTION

The invention relates to, among other things, a method of providing a service on a data network, and to a method of operating a server on a data network.

### BACKGROUND ART

Nowadays many users around the world are accessing the Internet frequently for many different purposes, e.g., finding information on all kind of topics, sharing information and experiences with other people, downloading music or movies, etc. Since there is so much information available on the Internet, both provided by companies but also by individual users, al kind of tools are provided to facilitate a user finding the information he actually needs or likes to find, e.g., search engines, and web portals. But these tools are still targeted to a large audience and not dedicated to an individual user.

By analyzing the web browsing activities of a user service providers and content providers can gain insight in the interests of individual users and better target search results and web portals.

U.S. Pat. No. 7,020,082, herein incorporated by reference, discloses a network usage monitoring module for monitoring network usage at a network access point, i.e., network traffic aggregation point, typically at a gateway device or a similar network interface device. As such, the network usage monitoring module can monitor the usage of a number of network users who are attempting to access various network services provided via the gateway device. Thus, the usage information collected by the usage monitoring module is considerably more robust than that offered by conventional monitoring techniques. As such, the information is considerably more valuable to network service providers, network users, network beneficiaries and the like. In addition, the usage monitoring method and apparatus offers a number of particular features to improve the monitoring process as well as the value of the usage information that is collected.

The drawbacks of this module are that usage is monitored on a per user basis, that the content of the websites visited by the user is not taken into account, and that the usage is stored based on a subscriber identity that is only known within the module.

U.S. Pat. No. 6,256,633, herein incorporated by reference, discloses a method of enabling a user to navigate through an electronic data base in a personalized manner. A context is created based on a profile of the user, the profile being at least partly formed in advance. Candidate data is selected from the data base under control of the context and the user is enabled to interact with the candidates. The profile is based on topical information supplied by the user in advance and a history of previous accesses from the user to the data base. A drawback of this personal navigation is that the profile is formed per individual user, so that the user is to be very specific about the topical information supplied in advance or is to have a long history of accesses so as to be able to extract his/her profile. Another drawback is that the user more or less relinquishes his/her privacy.

### SUMMARY OF THE INVENTION

The invention provides an alternative to the known approaches by taking into account the collective behavior of multiple users in a client-server architecture of a data network.

The inventor proposes a method of providing a service on a data network. The data network comprises a plurality of clients and a further plurality of servers. Each specific one of the plurality of the clients has a specific one of a plurality of network addresses. The method comprises dividing the plurality of network addresses the network addresses into multiple groups. Each respective one of the groups has a respective one of multiple profiles. Each respective profile is determined by one or more respective commonalities in requests sent by the plurality of clients to the further plurality of the servers over a period of time. Each specific network address is allocated to at least one specific one of the groups based on specific ones of the requests sent by the specific client, wherein the allocating is independent of to which particular ones of the further plurality of the servers the specific requests were sent.

According to the invention, the profiles are formed by detecting commonalities in sub-sets of the collection of requests. The requests issued from the network addresses of the sub-set having a feature in common (e.g., the same URLs, access to web sites addressing the same topic) are assigned a profile reflecting this commonality.

In an embodiment, consider a particular one of the further plurality of the servers that receives a particular one of the requests from a particular one of the plurality of the clients, or consider another server receiving another request from a particular one of the plurality of clients. As to the latter other server, the other server need not have been one of the plurality of servers for which the requests were profiled as for the aforesaid plurality of servers. The receiving server, now, is enabled to determine a particular one of the profiles associated with the particular network address of the particular client. This particular server then can configure its response based on the profile. There are various ways for enabling the particular server to determine the profile, relevant to an individual request. In a first example, a network access point, e.g., a router on the data network, is enabled to submit with the particular request an identifier of the particular profile. In a second example, the particular client is enabled to submit with the particular request an identifier of the particular profile. In a third example, the particular server receives an identifier of the particular profile via another service provider, e.g., upon request from the particular server. In a fourth example, the particular server comprises a search engine, and the search engine is provided with access to a database storing the multiple profiles, so as to be able to index the multiple profiles.

In a further embodiment, further network addresses of the further plurality of the servers are clustered in respective clusters representative of the respective profiles. Then, one or more of the clients can be provided with access via the data network to the further plurality of servers per individual cluster. For example, a service provider on the Internet provides access to a web page of one or more clusters of URLs that belong to one or more profiles. This then gives an outsider to the field of the profile, or a novice in the field of the profile, some insight in what a certain group of people, complying with this profile, consider interesting.

The commonalities, referred to above, are based on, e.g., similarities of identifiers of web pages (e.g., URLs) identified in the requests. Alternatively, or in addition, the content (e.g., the semantic content information) is analyzed of web pages identified in the requests, and the commonalities are based on similarities of the analyzed content.

In yet a further embodiment, an individual client is enabled to determine a particular profile associated with a certain network address of another one of the clients. For example, the other client submits an identifier of the particular profile to the individual client in a data communication via the data network. An email as received, for example, comprises the particulars of the network address of the sender. The receiver then can determine the profile of the sender based on his/her network address. As another example, the receiving client is given access to a database associating network addresses with one or more profiles. Such database is created as has been discussed above.

In still another embodiment, a server on the data network may benefit from the availability of the profiles. To this end, the invention provides a method of operating a server on a data network. The data network comprises multiple clients, each respective one thereof having a respective one of multiple network addresses; and a database associating each respective network address with a respective one of a plurality of profiles, indicative of a respective commonality in requests sent by the clients via the data network. The method comprises receiving a specific request from a specific one of the clients; identifying the network address of the specific client; consulting the database to identify a specific one of the profiles associated with the network address of the specific client; and serving via the data network the client with a response configured on the basis of the profile. A service with a search engine may benefit as well by grouping client addresses under profiles, so as to tailor the search results to the profile of the group of the client who submits a search request. Preferably, the search engine manages the database.

The invention also is applicable to mobile Internet browsing. The expression “Mobile Web” has been coined and refers to the world-wide web as accessed from mobile devices such as cell phones, network-enabled personal digital assistants (PDAs), and mobile computers such as small laptops. A mobile browser is a web browser designed for use on such a mobile device. Users can browse the Internet from their mobile devices via, e.g., UMTS (Universal Mobile Telecommunications System) networks, GPRS (General Packet Radio Service) 3G networks, etc. The mobile telephones connect to the Internet via a gateway, functionally similar to scenarios of the clients accessing the Internet via a router as discussed above. Accordingly, where reference is made to a client throughout this text, the term “client” is also meant to cover a mobile network-enabled device where appropriate in view of the context.

### BRIEF DESCRIPTION OF THE DRAWINGS

The invention is explained in further detail, by way of example and with reference to the accompanying drawings, wherein:

FIGS. 1-7 are diagrams of systems in the invention.

Throughout the Figures, similar or corresponding features are indicated by same reference numerals.

### DETAILED EMBODIMENTS

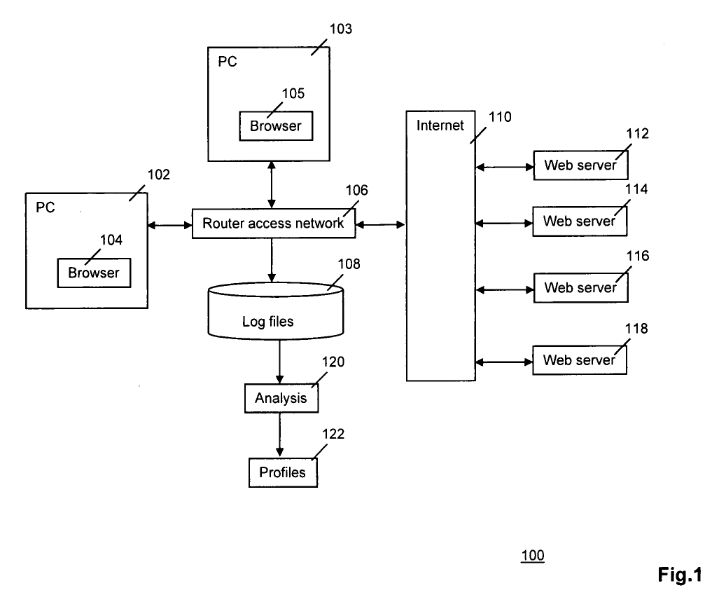

FIG. 1 is a diagram of a system 100 in the invention. System 100 comprises a client 102, e.g., a PC 102 with a browser 104, and a client 103, e.g., a PC 103 with a browser 105, a router access network (or another network access point) 106, a memory 108 for storing log files, a data network 110 such as the Internet, and a plurality of web servers 112, 114, 116 and 118. FIG. illustrates only clients 102 and 103, and does not show more clients in order to not obscure the drawing. Access routers 106 are operative to log all HTTP request from the clients, e.g., clients 102 and 103, in log-files of memory 108. The log files contain the IP address from which the request originated and the destination URL of the requested website residing at one of servers 112-118, from now on referred to as “URL”. The set of URLs requested by the same IP address is referred to as a “click stream”. In this text it is assumed that there is a one-to-one relationship between an IP address and the user at the client associated with this IP address. Accordingly, in this example, the user of PC 102 is associated with a first IP address and the user of PC 103 is associated with a second IP address different from the first IP address.

System 100 comprises a module 120 for analyzing the click streams originating at different IP addresses in order to group the IP addresses based on their click streams having one or more attributes in common, e.g., the same URLs. Such a group of IP addresses whose respective click streams have one or more URLs in common are referred to as a “correlation group”. Users belonging to the same correlation group have correlation in the URLs they browse to. As each correlation group is formed because its being based on a particular commonality, each correlation group has a particular profile representative of this commonality. Data about these profiles are stored in a database 122 that can, but need not, be part of memory 108. Correlation groups can be created in a variety of ways, e.g., with or without being noticed by the user; based on all browsing behavior of the user with regard to the whole Internet; based on all users passing access router 106, etc. The profiles are determined, e.g., by analyzing the semantic content (keywords, topics, etc.) of the web sites indicated by the URLs associated with the groups.

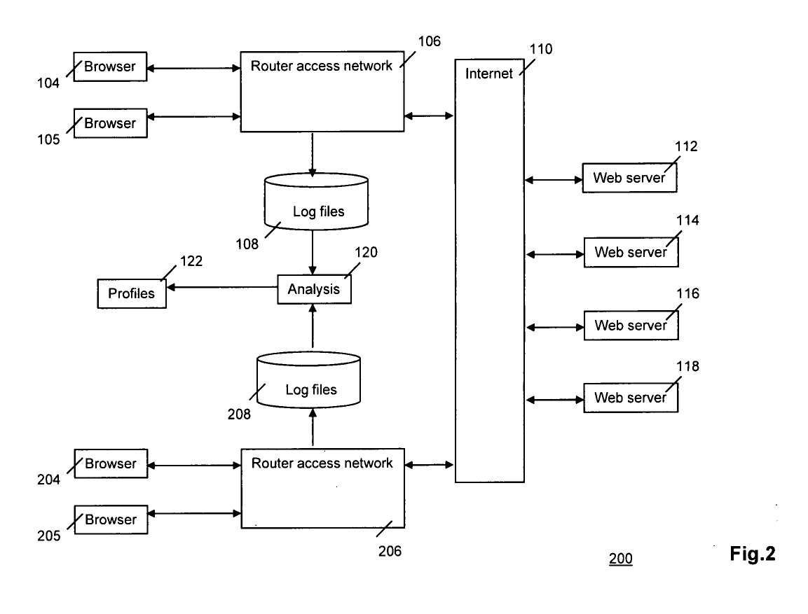

FIG. 2 is a diagram of another system 200 of the invention. System 200 includes system 100 as discussed under FIG. 1, plus browsers 204 and 205 residing at other clients (not shown), an access router network (or network access point) 206 and a memory 208 for storing the log files of the clients associated with browsers 204 and 205. Now, profiles are formed based on the HTTP requests via access routers 106 and access routers 206. System 200 can be expanded by including more access routers (not shown) and by taking their log-files into account as well.

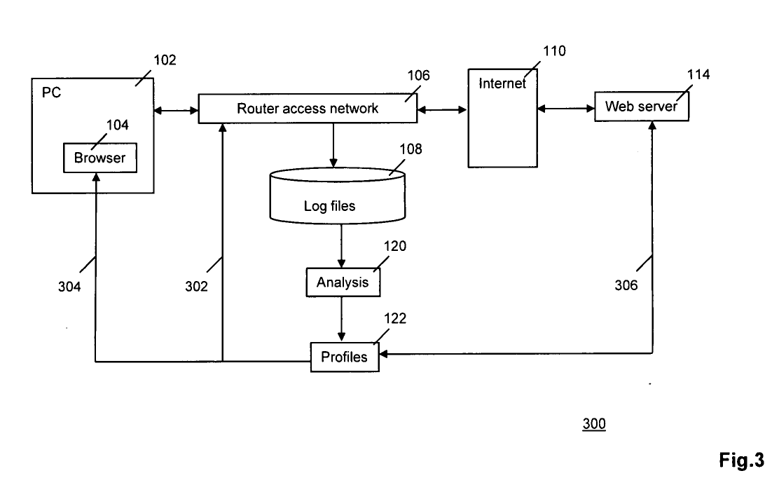

FIG. 3 is a diagram of a system 300 in the invention explaining how profiles can be used. A specific profile identifier is assigned to a specific one of the profiles in memory 122. The profile identifier of the profile associated with the client 102 can be inserted (reference numeral 302) into the request originating from browser 104 at router 106, or at browser 104 itself (reference numeral 304), or profile data can also be requested (reference numeral 306) by web server 114 upon receiving the original request. In any case, web-server 112 can then adapt the response to the request (e.g., the requested web page) to the profile of the client identified by the profile identifier or further processing the combined information about the request and the profile (e.g., for demographic purposes).

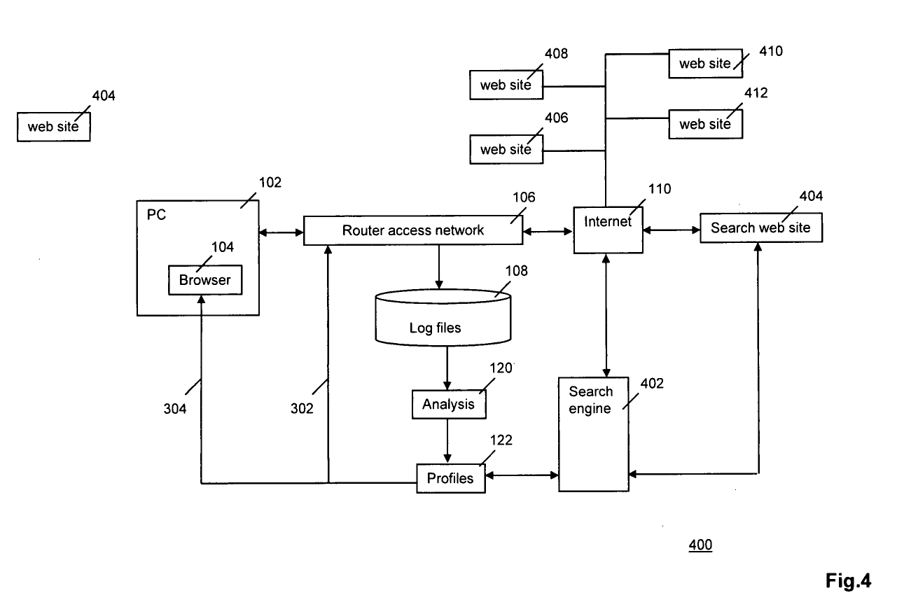

FIG. 4 is a diagram of a system 400 in the invention to illustrate the approach of system 300 with reference to search engines. System 400 comprises a search engine 402 that is accessible through a search web site 404.

Analysis module 120 has determined the key-words representative of the profiles of the correlation groups after indexing the web-sites of the log-files in memory 108. For example, a first correlation group is associated with URLs of sites relating to fruit farmers, and URLs related to fruit auctions; and a second correlation group is associated with URLs of sites of car manufacturers, and URLs of sites relating to rally racing.

Search web-site 404 receives a search request from client 102 that includes a search term “citroen” (Dutch for “lemon”). Search engine 402 returns to browser 104 a response that depends on the correlation group to which the IP address of client 102 belongs. Search engine 402 is notified of the correlation group, e.g., via browser 104 inserting a profile identifier for the IP address of client 102, or router 106 inserting the profile identifier, or upon search engine 402 requesting a profile from database 122 for the IP address of client 102. Alternatively, database 122 contains both information about the profiles extracted by analysis module 120 and the associated IP addresses, and search engine 402 has access to database 122. Search engine 402 is then enabled to index database 122. If search engine 402 finds that the IP address belongs to the first correlation group, site 404 returns a list of URLs of the sites relating to lemon fruits, e.g., sites 406 and 408. If the IP address of the request belongs to the second correlation group, site 404 returns a list containing URLs of sites relating to the car brand “Citroen”, e.g., sites 410 and 412. In another scenario, site 404 returns an aggregate list, including the URLs of sites 406-412. Site 404 then has the URLs of sites 406 and 408 ranked higher than the URLs of sites 410-412 in the aggregate list returned to the IP address whose dominant profile is associated with fruits. Similarly, site 404 has the URLs of sites 410-412 ranked higher than the URLs of sites 406-408 in the aggregate list returned to the IP address whose dominant profile is associated with cars.

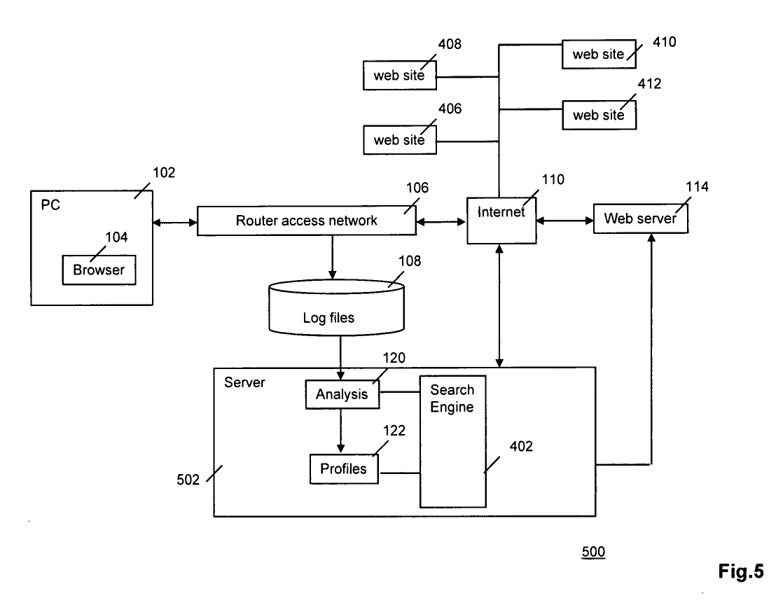

FIG. 5 is a diagram of a system 500 in the invention according to a variation on the theme of system 400. In this case, search engine 402, analysis module 120 and database 122 form functional parts of a server 502. Server 502 has determined the correlation group of the IP address by analysis module 120, and profile database 122 contains both the profiles and the associated IP addresses. This configuration does neither involve user interaction nor router action. It is all contained in search engine system 502, which indexes the Worldwide Web according to use or source: the activity of the user. This is new, because known systems index the Worldwide Web according to the target or web site, and these systems just visit all the web-sites.

Profiles can be richer than just correlation groups introduced above. If web-sites of click-streams are analyzed, cultural profiles can be created. For example, click-streams containing web-sites of motorcycles and of rock-bands result in a “tough adventure” profile, whereas wildlife photography sites and of outdoor sites will result in “nature” profile. These enhanced profiles are referred to below as “cultural profiles”.

Based on cultural profile, the results of the search engine can be more relevant than without profile. The cultural profile adds context to the search request which can help to create a more relevant response. For example, the search term “Ford” can result in multiple disjoint sets of search results: automobile-related (Henry Ford) for “car-profile” and book-related (Richard Ford) for “literature profile”.

Using cultural profiles information can be added to the search request which has not been identified directly in correlation groups. In creating cultural profiles, there is an additional step with respect to correlation groups: the step of “cultural profiling”. This step is not shown separately in FIG. 5.

The method and system for click-stream enhanced search for correlation groups and cultural profiling is identical in both situations, except for the creation of the additional cultural profiles.

Web sites other than those giving access to a search engine can also use the correlation groups and cultural profiling as is discussed below.

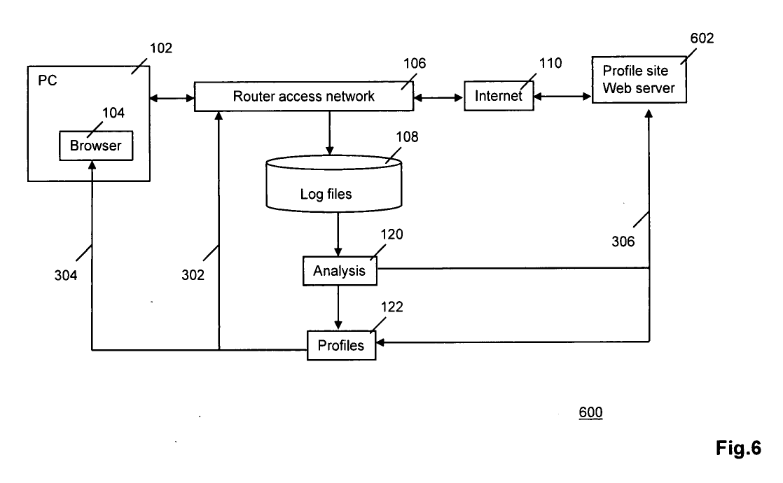

Reference is now had to FIG. 6. The expression “correlation profile site” is used in this document to refer to a site 602 which contains the URLs associated with one or more correlation groups. Without analyzing these URLs or the content of their web pages, correlation profile site 602 merely provides a set of URLs. If a person visits the sites identified by these URLs listed on the profile correlation site, this person visits the sites that the people of this group have been visiting and that have given rise to the specific grouping of IP addresses as discussed above. Correlation group information can, again, be added by browser 104, router 106, or be requested by profile site 602. To a visitor of site 602, the URLs listed are meaningless themselves, as information about the actual content of the web-sites of these URLs is not provided.

Profile sites, such as site 602, can be made more meaningful to a visitor by analyzing the content of the sites of the URLs and adding some information based on the analysis. By adding such content to profile site 602, profile site 602 is made more meaningful and interesting to a visitor, and can serve as a portal for members of a community having a certain profile.

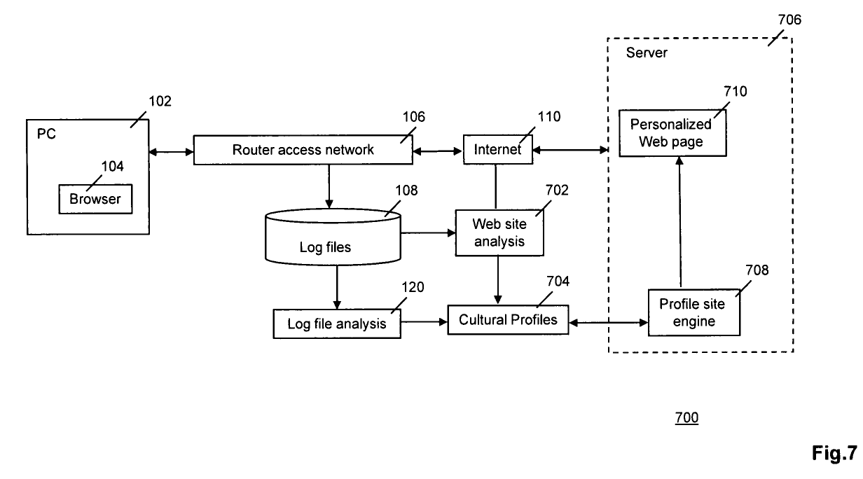

An even more interesting way to use profiles for web sites, is to create the cultural profiles, described above for search engine, and use this cultural profile for serving content of a web-site modified on the basis of such cultural profile. This is similar to the cultural-profile enhanced search, but now instead of a search-result, individual web-pages of an individual web site are adapted to the cultural profile of the user of client 102 requesting access. This is illustrated in the diagram of system 700 in FIG. 7.

System 700 comprises a web site analyzer module 702 that analyzes the content of the web sites identified by the URLs logged in memory 108. In combination with the network addresses of the clients submitting the requests for access to these sites, the client's addresses can be grouped as being associated with one or more cultural profiles in a database 704. System 700 comprises a server 706 that is operative to serve a web page to requesting client 102. Upon receipt of the request from client 102, server 706 requests from database 704 the cultural profile associated with the network address of client 102. Server 706 then uses this cultural profile to compile or otherwise create a web page whose content is specifically adapted to the cultural profile listed in database 704 for client 102.

As an illustration, assume that a first client has a cultural profile that can be termed “nature” and that another client has a cultural profile that can be termed “sporty”. Further assume that server 706 is a home server of a car manufacturer. Then, the web site, e.g., home page, of a car manufacturer, to which a client requests access via data network 110, is adapted per client and based on the cultural profile. If client 102 is listed as having the sporty cultural profile, a profile site engine 708 of server 706 extracts this information from database 704 based on the IP address of requesting client 102 and modifies their start-page 710 as served to client 102 so as to show their newest sports car. If client 102 is listed with the nature profile in database 704, server 706 operates in a similar manner to have their start page show an all-terrain car. The above described method and system support this without user-intervention, even without the user being aware of the personalizing process.

Other applications can be based on cultural profiling according to the above method.

Dating sites and social communities can use the cultural profiles for matching and initiating interesting contacts. A user can submit a request that boils down to, e.g., “I am looking for a person in profile XYZ with or without knowing his/her own profile. The site then provides contact information about a person of the XYZ profile, who in turn is looking for someone with the user's profile. Both individuals need not know their own profile or need not be aware of the profiling going on in the background.

Other example scenarios include the following.

Lawful interception: looking for IP addresses belonging to a certain correlation group or having a certain profile; looking for web-sites belonging to a certain correlation group.

Recruiting agencies and Job/vacancy sites, Human Resource Management of companies can use the above. In the case of a vacancy database, e.g., Monster board, an applicant's IP address can be used to determine his/her cultural profile as described above for personalized web sites. If a company is looking for hiring an employee with a certain cultural profile, and an applicant submits a resume or curriculum vitae by email, the company can use the IP address of the e-mail sender to determine the cultural profile by means of submitting a request to the profile database. Accordingly, click-stream analysis can be used to determine the cultural profiles of e-mail senders, linking them by their IP addresses.

If one wants to create a music band/a cultural diverse group such as in theatre or a television cast, one can use the above profiling methods.

Click-stream analysis could also be used in an intra-company/organization/closed user-group setting, such as an intranet, e.g., providing the possibility to create an overview of employees knowledgeable about (or at least interested in) certain areas or technologies. The IP address enables to contact the person, preserving anonymity until the user decides to reveal his/her identity.

Below is an overview of various scenarios summarizing example embodiments of the invention.

| | | Create | | |
|---|---|---|---|---|
| | | web-portal | | |
| | Viewed | site based | Create search | Create |
| Item | page | on | site based on | personalized |
| analyzed | analyzed | analysis | analysis | web-site |
| 1) URL | No | Top URL | Results can be | Not possible |
| | | site for | used to place | |
| | | population | results of any | |
| | | | search engine | |
| | | | in order of | |
| | | | most viewed | |
| | | | URL of this | |
| | | | population | |
| 2) URL | yes | Top | Results are a | Not possible |
| | | subject | search engine | |
| | | site URLs | for this | |
| | | for | population | |
| | | population | itself: the | |
| | | | results are | |
| | | | sites where | |
| | | | the population | |
| | | | browses to | |
| 3) IP | No | Top URL | Results can be | Not possible |
| address | | site for | used to place | |
| | | correlation | results of any | |
| | | group | search engine | |
| | | | in order of | |
| | | | most viewed | |
| | | | URL of this | |
| | | | correlation | |
| | | | group | |
| 4) IP | Yes, | Top | Results are a | Personalized |
| address | Without | subject | search engine | web site |
| | cultural | site for | for this | based on |
| | profile | correlation | correlation | interest |
| | | group | group itself: | groups |
| | | | the results | |
| | | | are sites | |
| | | | where the | |
| | | | correlation | |
| | | | group browses | |
| | | | to | |
| 5) IP | Yes, | Top | Add cultural | Personalized |
| address | With | subject | profile to | web site |
| | Cultural | site for | relevance of | based on |
| | profile | cultural | search results | cultural |
| | | profile | | profile |
| | | groups | | |

Row 1) of above table refers to a scenario wherein all URL requests can be ranked according to frequency. That is, a first URL has been requested a first number of times, and a second URL has been requested a second number of times, all within a certain time period or since a start time. This then enables a ranking of URLs, based on their frequencies in the requests as monitored for the profiling purposes as discussed above. Note that in this scenario the ranking of search results in the response of a search engine can be transformed to another ranking reflecting the interests of the user population monitored. Also, a portal can be created for the monitored population with direct access to the Web sites, most popular with the monitored population, selected on the basis of the frequencies. Alternatively, or in addition, the browser of the user device adds to the request information, e.g., a user-agent string, about the device. The user-agent string is indicative of e.g., brand of the device, type of the device, type of the browser of the device, versions thereof, etc.). This then enables the service provider, e.g., a provider of a search engine for mobile users, to rank or otherwise categorize the URLs according to the brands and types of the mobile devices that have issued the requests. This can be shown to the user without any additional steps to be performed by the user, as the browser of the device also adds the user-agent-string to the request submitted to the web-site or search-engine. Hence, the search-engine or web-site can use this as a criterion to determine the results for that specific request of that specific device. In turn, the web pages associated with the URLs most frequently accessed by specific mobile devices can be made accessible in a portal especially developed for these specific mobile devices. This development can be carried out on an ongoing basis, so that the sites, which are the most popular with a specific type or brand of mobile device, are always readily accessible.

For completeness, the expression “user agent” is a common expression in the technical field and refers to a client application used with a particular network protocol. Within the context of the Internet, the user agent is the application (e.g., a browser or a crawler) that accesses the World Wide Web. Within the context of the Session Initiation Protocol (SIP) the expression “user agent” typically refers to the user's telephone. When a user visits a web site on the Internet, a text string is sent in order to identify the user agent with respect to the server. This forms part of the HTTP request, prefixed with the string “User-agent” or “User-Agent”. This typically includes information such as the application name, version, host operating system, hardware and language.

These scenarios can even be taken further if one takes into account, e.g., the extension of the URL, without having to analyze the content information itself of the associated site. The extensions indicate whether the content information is a movie file, an audio file, a ringtone, plain HTML, etc. Accordingly, the files (e.g., ringtones) that are downloaded most often or the sites providing such files (e.g., a site providing access to a ring-tone database) and visited most often, can be ranked at the top of the list when responding to a request issued by a specific device.

Row 2) of above table refers to the scenario, wherein the semantic content of the web pages is analyzed, the pages being identified by the URLs in the monitored requests. Now, a division can be made according to topic, and search results of a query about this topic can be ranked according to, e.g., their frequencies derived from the requests from the monitored population.

Note that search engine providers do not have the means to monitor web accesses to other servers. Accordingly, they cannot tailor the search results to the (browsing) behavior of the monitored population. In particular, a server has in general information about all requests received at its address. A search engine can document all search requests submitted to it. However, only a network access point, e.g., a router, can monitor all requests submitted by the population using the access point, independent of the destination (e.g., a specific server or search engine) of the request. Accordingly, the network access point has information about the different sites to which requests are sent as well as about the population served via this access point. For a large enough population, the requests can be profiled as discussed above, the profiles then conveying significant information about the population and the group behaviors of different groups or sub-sets in the population.

Devices with mobile browsers typically have limited capabilities with regard to screen real estate, user interactivity, onboard memory, etc. For users of such devices, it is important to be able to readily find those network sites that are suitable for these devices. The invention therefore enables these users to readily find these sites, because their URLs are automatically being ranked at the top of the list of URLs of the requests submitted from mobile devices, precisely as a result of their being submitted most often from mobile devices of the same category or profile.

Some devices are more popular with certain segments of the population than with other segments, e.g., as a result of marketing and advertising campaigns targeting certain segments. For example, the Motorola Pebble and LG Chocolate are mobile phones particularly appreciated by women between 30 and 40 years young, whereas the Sony-Ericsson mobile phones are largely very popular with teenagers. Accordingly, these devices already segment the population. As a result, a correlation can be assumed to exist between a user of such a particular device on the one hand and his/her interests on the other. Now, by ranking the URLs according to both population segment and device capabilities, chances are increased that the URLs higher in the ranking are more interesting to these particular users than other URLs (lower in the ranking or not even ranked). It has been assumed here that as a result of marketing campaigns and segmenting by the telecom operators, target groups of these segments share a common interest in the information content of web sites as a result of their shared preference for a specific device type. Accordingly, the population can be segmented as a result of marketing campaigns. People belonging to a specific population segment have an attribute in common, such as browsing behavior, interest, age. These different segments form target groups for different mobile devices. As a consequence, a specific population segment has one or more commonalities with regard to the devices being used in that specific segment. If the ranking of accessed URLs is now being used at, e.g., search engines and portals, the ranking as based on device capabilities directly or indirectly inferred, then the segmenting is automatically applied according to the marketing campaigns. This scenario applies in general to all browsers. For example, a distinction can be made between Microsoft Internet Explorer and Firefox at the PC level.

Row 3) of above table refers to a scenario wherein the scenario of row 1) is applied to correlation groups. Accordingly, URLs can be grouped according to a profile assigned to a specific group of IP addresses. Within such group, the URLs can again be ranked according to frequency as measured within such group.

Row 4) of above table refers to a scenario wherein the scenario of row 2) is applied to correlation groups. Accordingly, URLs can be grouped according to topics of interest to a specific group of IP addresses belonging to a certain profile.

Row 5) refers to scenarios already extensively discussed above.

1. A method of providing a service on a data network, wherein:
the data network comprises a plurality of clients and a further plurality of servers;
each specific one of the plurality of the clients has a specific one of a plurality of network addresses;
the method comprises:
dividing the plurality of network addresses into multiple groups, wherein:
each respective one of the groups has a respective one of multiple profiles;
each respective profile is determined by one or more respective commonalities in requests sent by the plurality of clients to the further plurality of the servers over a period of time; and
in a database, allocating each specific network address to at least one specific one of the groups based on specific ones of the requests sent by the specific client, wherein the allocating is independent of to which particular ones of the further plurality of the servers the specific requests were sent.

2. The method of claim 1, further comprising enabling a particular one of the further plurality of the servers that receives a particular one of the requests, or enabling another server that receives another request, from a particular one of the plurality of the clients to determine a particular one of the profiles associated with the particular network address of the particular client.

3. The method of claim 2, wherein the enabling comprises configuring a network access point on the data network to submit with the particular request an identifier of the particular profile.

4. The method of claim 2, wherein the enabling comprises configuring the particular client to submit with the particular request an identifier of the particular profile.

5. The method of claim 2, wherein the enabling comprises providing to the particular server an identifier of the particular profile.

6. The method of claim 5, wherein the identifier is provided upon a further request from the particular server.

7. The method of claim 5, wherein:
the particular server comprises a search engine; and
the method comprises providing the search engine with access to a database storing the multiple profiles for indexing the multiple profiles.

8. The method of claim 1, wherein the commonalities are based on similarities of identifiers of web pages identified in the requests.

9. The method of claim 1, comprising analyzing content of web pages identified in the requests, and wherein the commonalities are based on similarities of the analyzed content.

10. The method of claim 1, comprising:
clustering further network addresses of the further plurality of the servers in respective clusters representative of the respective profiles; and
providing at least particular ones of the clients with access via the data network to the further plurality of servers per individual cluster.

11. The method of claim 1, further comprising enabling an individual one of the clients to determine a particular one of the profiles associated with a certain one of the network addresses of a certain other one of the clients.

12. The method of claim 11, wherein the certain other client submits an identifier of the particular profile to the individual client in a data communication via the data network.

13. The method of claim 11, wherein the individual client is given access to a database associating each specific network address with a particular one of the profiles.

14. A method of operating a server on a data network, wherein:
the data network comprises:
multiple clients, each respective one thereof having a respective one of multiple network addresses;
a database associating each respective network address with a respective one of a plurality of profiles, indicative of a respective commonality in requests sent by the clients via the data network;
the method comprises:
receiving a specific request from a specific one of the clients;
identifying the network address of the specific client;
consulting the database to identify a specific one of the profiles associated with the network address of the specific client; and
serving via the data network the client with a response configured on the basis of the profile.

15. The method of claim 14, wherein the requests from the clients are addressed to the server.

16. The method of claim 15, comprising managing the database.

17. The method of claim 15, wherein the requests from the clients are addressed to one or more other servers on the data network.
